(19) United States
(12) Patent Application Publication
(10) Pub. No.: US 2018/0056330 A1
(43) Pub. Date: Mar. 1, 2018

(54) NON-CIRCULAR ACCELERATION MECHANISM FOR A SINGLE SHAFT SCREEN

(71) Applicant: TEREX USA, LLC, Westport, CT (US)

(72) Inventors: Michael Peter Stemper, Marion, IA (US); Ryan Anthony Mumm, Newhall, IA (US)

(21) Appl. No.: 15/691,927

(22) Filed: Aug. 31, 2017

Related U.S. Application Data
(60) Provisional application No. 62/381,937, filed on Aug. 31, 2016.

(51) Int. Cl. B07B 1/42; B07B 1/30

(52) U.S. Cl. CPC B07B 1/42; F16H 1/28; B07B 1/30

(57) ABSTRACT

A single shaft material processing vibrating screen is described which provides for non-circular acceleration (elliptical and otherwise). The system includes a main eccentric is rotated a first direction and a secondary eccentric orbits the main eccentric in an opposite direction.

The orbiting is accomplished by either long and short arms or by eccentric flywheels. The size and shape of elliptical/non-circular motion is adjustable by varying mass of main and secondary eccentrics, length of long and short arms or the size of eccentric flywheels.

### CROSS REFERENCE TO RELATED APPLICATIONS

The present application claims the benefit of the filing date of provisional patent application having Ser. No. 62/381,937 filed on Aug. 31, 2016 by the same inventors, which application is incorporated herein in its entirety by this reference.

### FIELD OF THE INVENTION

The present invention generally relates to material processing, and more particularly relates to vibrating screens, and, even more particularly, relates to vibrating screens which are capable of horizontal operation.

### BACKGROUND OF THE INVENTION

In the past, many vibrating screens have been used exclusively in a substantially horizontal deployment. Such systems would typically be a three shaft vibrating screen having a longitudinal triple gear-gear box disposed on the screen.

While these types of three shaft vibrating screen systems may have many advantages in particular applications, they also have some drawbacks. For example, in many three shaft devices it may be required to incline the screen to increase the rate at which material propagates along the surface of the screen. However, it is usually problematic to incline such three shaft vibrating screen by a substantial amount because of the problems in lubricating the gears in the gear box. These three shaft screens are also generally larger and heavier than a typical single shaft screen which is operated in an inclined orientation.

Consequently, there exists a need for improved methods and apparatuses for processing material with a vibrating screen.

### SUMMARY OF THE INVENTION

It is an object of the present invention to provide a vibrating horizontal screen that has easy internal adjustability of the propagation rate of material along the screen.

It is a feature of the present invention to utilize a single, across the screen shaft, vibrating screen with an adjustable acceleration characteristic.

It is an advantage of the present invention to provide for reduced material and weight.

It is another advantage of the present invention to provide the ability to substantially adjust the propagation rate of material along the screen without changing either of the angle of inclination of the screen or the across the screen shaft rotation rate.

The present invention is an apparatus and method for efficiently and cost effectively providing a variable screening operation which is designed to satisfy the aforementioned needs, provide the previously stated objects, include the above-listed features, and achieve the already articulated advantages. The present invention is carried out in a single shaft manner, in a sense that only a single shaft extends across the screen to drive the rotation of vibration inducing weights located on each side of the screen.

### BRIEF DESCRIPTION OF THE DRAWINGS

The invention may be more fully understood by reading the foregoing description of the preferred embodiments of the invention, in conjunction with the appended drawing wherein:

FIG. 1 is a simplified conceptual geometric drawing of the relative motion relationships of portions of the present invention, where the arrows show the directions of rotation.

FIGS. 2-8 are variations of the representation of present invention of FIG. 1 where the portions are shown in a series of equally spaced intervals.

FIG. 9 is a simple example of an alternate embodiment of the present invention which utilizes an internal/external gear arrangement, configuration corresponding to FIG. 1.

FIG. 10 is the embodiment of FIG. 9, which is oriented so as to correspond with FIG. 2.

FIG. 11 is another simple example of an alternate embodiment of the present invention, which utilizes a cog belt which corresponds with FIG. 1.

FIG. 12 is the embodiment of FIG. 11 where the configuration corresponds with FIG. 2.

FIG. 13 is an embodiment of the present invention with a non-elliptical and non-circular stroke.

FIGS. 14-21 are the embodiment of FIG. 13 in a series of equal angular motions.

FIG. 22 is a system of the present invention in a representative environment.

FIG. 23 is a representation of an elliptical stroke path of the present invention for a configuration as shown in FIGS. 1-8.

FIG. 24 is an adjusted elliptical stroke path of the present invention where the configuration is different from FIGS. 1-8.

### DETAILED DESCRIPTION

Although described with particular reference to a horizontal mobile vibrating screen, the system and method for processing material with a vibrating screen can be implemented in many different ways and settings and degrees of inclination.

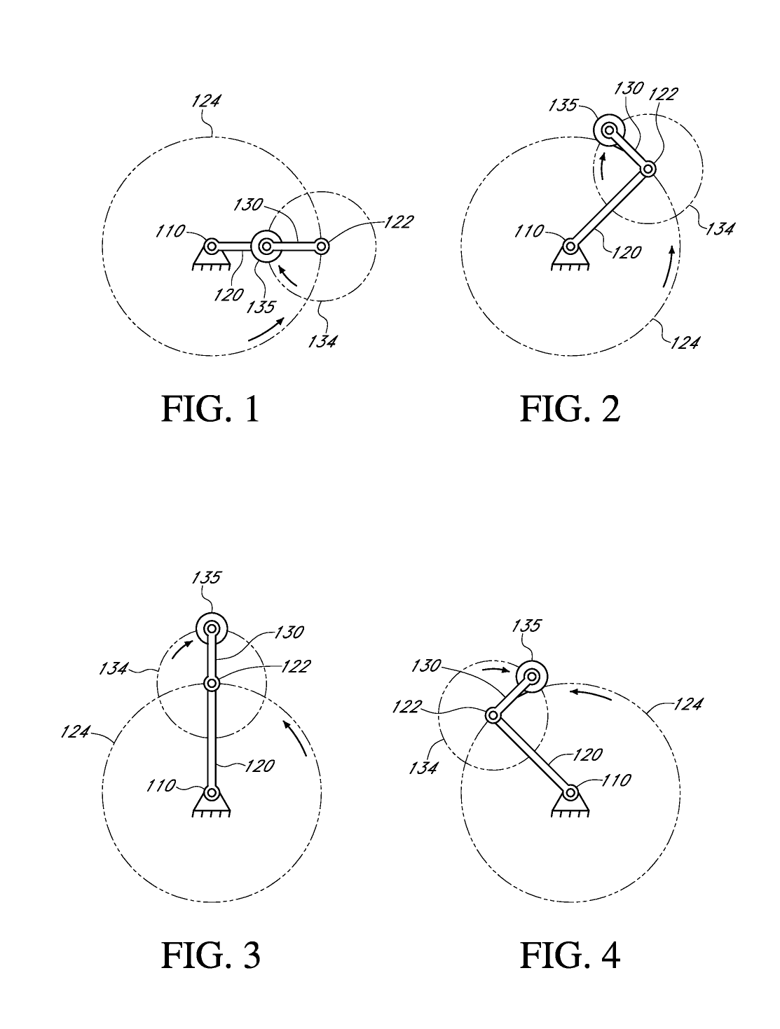

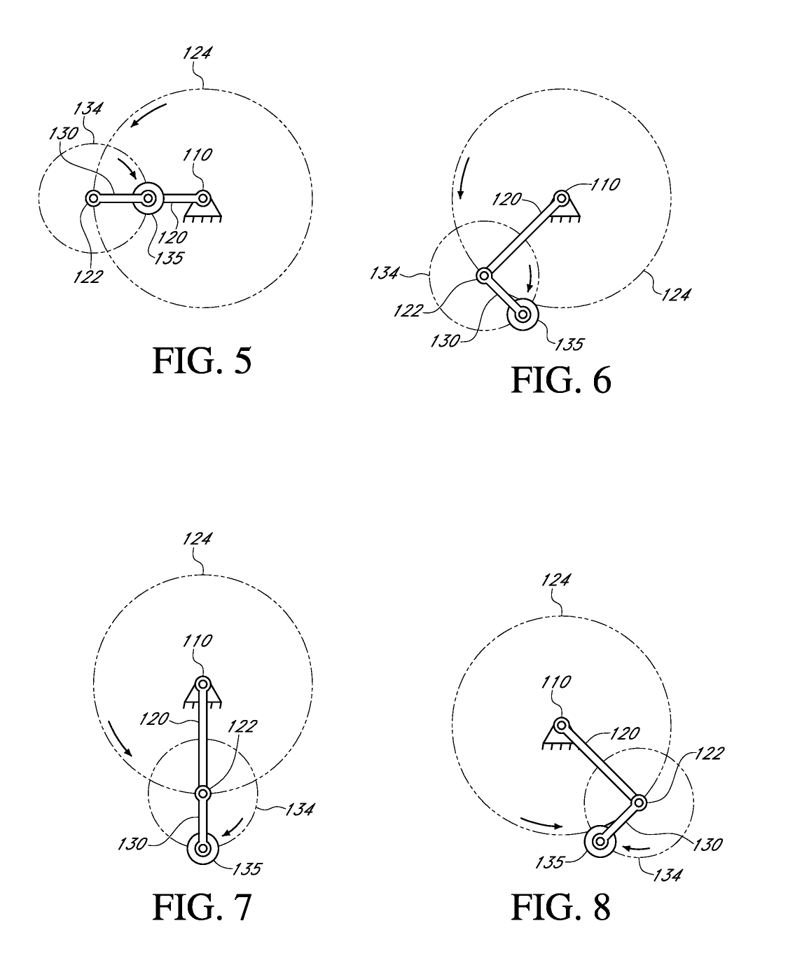

Now referring to the drawings wherein like numerals refer to like matter throughout and more particularly now referring to FIGS. 1-8, there is shown one embodiment of the present invention which provides for an easily understandable explanation of the concept of the present invention. Other alternatives discussed later may be preferable for manufacturing and other practical reasons. FIGS. 1-8 show a central point which could be viewed as an end of a single shaft 110, which could be thought of as being massless for ease of understanding. When used in a mobile single shaft vibrating screen with adjustable screen stroke 100, this is the only shaft that extends from one side of the mobile single shaft vibrating screen with adjustable screen stroke 100 to the opposite side for the purpose of turning massive eccentrics which induce vibration for the operation of the mobile single shaft vibrating screen with adjustable screen stroke 100. Only one side of the mobile single shaft vibrating screen with adjustable screen stroke 100 and one end of the single shaft 110 are shown in FIG. 1. The present invention induces vibration to move the material across the surface of the screen deck of the mobile single shaft vibrating screen with adjustable screen stroke 100, by moving a mass 135 in a predetermined manner by providing a single shaft 110 which rotates around its central axis, and a long arm 120 coupled to it which also rotates around the central axis of single shaft 110. For the purpose of explanation, long arm 120 might be most easily thought of as being a rigid massless arm. The line 124 is a line representing the circle drawn by a distal end 122 of the long arm 120 as it rotates around single shaft 110. Coupled to long arm 120, at distal end 122, is a short arm 130, which also could be thought of as being massless and rigid. The line 134 represents the circle drawn by the short arm 130 when it rotates around the distal end 122 of long arm 120. If the line 124 is taken to resemble the face of a clock, then the long arm 120 is shown in a 3 o'clock position in FIG. 1. Short arm 130 is shown located such that its entirety is positioned in alignment with long arm 120. Mass 135 could be conceptually thought of as being a predetermined mass at an infinitely small point. Of course, actual implementation of the present invention will not involve massless arms and infinitely small massive structures. Alternate real structures could be utilized which attempt to emulate the movement of mass 135.

Now referring to FIG. 2, which represents the invention after the long arm has moved one eighth of an entire counter-clockwise rotation, or 45 degrees, to a 1:30 location while the mass 135 has rotated at twice the angular velocity, or 90 degrees, but in a clockwise direction. Short arm 130 is shown as a tangent line to line 124 at the distal end 122 of long arm 120.

Now referring to FIG. 3, which represents the invention after the long arm has moved another one eighth of an entire counter-clockwise rotation, or 45 degrees, to a 12 o'clock location while the mass 135 has rotated at twice the angular velocity, or 90 degrees, but in a clockwise direction. Short arm 130 is shown as a parallel extension to line 124 at the distal end 122 of long arm 120.

FIGS. 4-8 show the continued rotations of the long arm 120 and short arm 130. If the rotation were to continue one additional step of 45 degrees of rotation counter-clockwise for long arm 120 and 90 degrees clockwise for short arm 130, the drawing would be the same as shown in FIG. 1.

In operation, the mobile single shaft vibrating screen with adjustable screen stroke 100 may function as follows: the rotation of the mass 135 on the free end short arm 130 about the rotating distal end 122 of long arm 120 creates a desirable non-circular movement of the mass 135, which causes the material to propagate along the service of a screen deck even if it is substantially horizontal. The term “stroke” is used herein to refer to path that a given point on the surface of the screen deck would move during operation of the mobile single shaft vibrating screen with adjustable screen stroke 100.

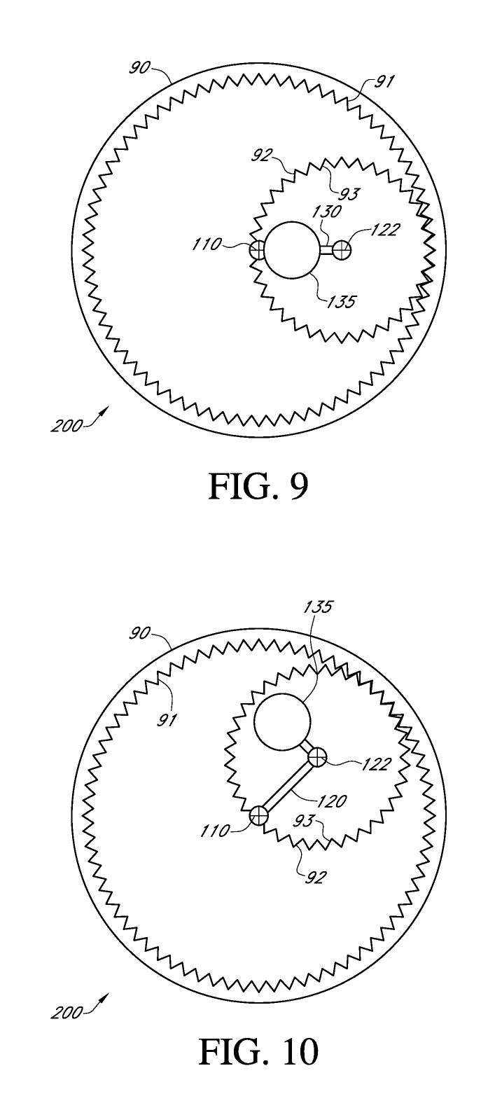

Now referring to FIG. 9, there is shown an alternate embodiment of the present invention which is designed to approach the operation of the embodiment of FIG. 1. An inside gear 90, having inside gear interior teeth 91 disposed entirely around an interior surface thereof, is configured to mesh with outside gear exterior teeth 93 of outside gear 92. The number of teeth and space of the teeth of inside gear 90 and outside gear 92 are configured so that a counter-clockwise revolution of inside gear 90 will result in two clockwise revolutions of outside gear 92. The resulting movement of mass 135 is similar to the movement shown in and described referencing FIG. 1.

Now referring to FIG. 10, there is shown an embodiment of FIG. 9 after a one eighth counterclockwise revolution of inside gear 90. The embodiment of FIGS. 9 and 10 can be continued further so as to emulate the operation of FIGS. 3-8. The angle alpha of the ellipse measured with respect to the horizontal can be adjusted from its 90 orientation, which would result from a configuration as shown in FIGS. 1-8 and 9-10. This adjustment of alpha provides for the ability for a horizontally disposed screen to vibrate with an angled elliptical stroke so that material disposed on the screen deck is caused to move both upward and along the screen deck either closer to an outlet end of the screen or away from an outlet end of the screen, depending upon whether the adjustment is intended to speed up or decrease the speed at which material moves along the screen toward an exit end. This adjustment can be accomplished as follows:

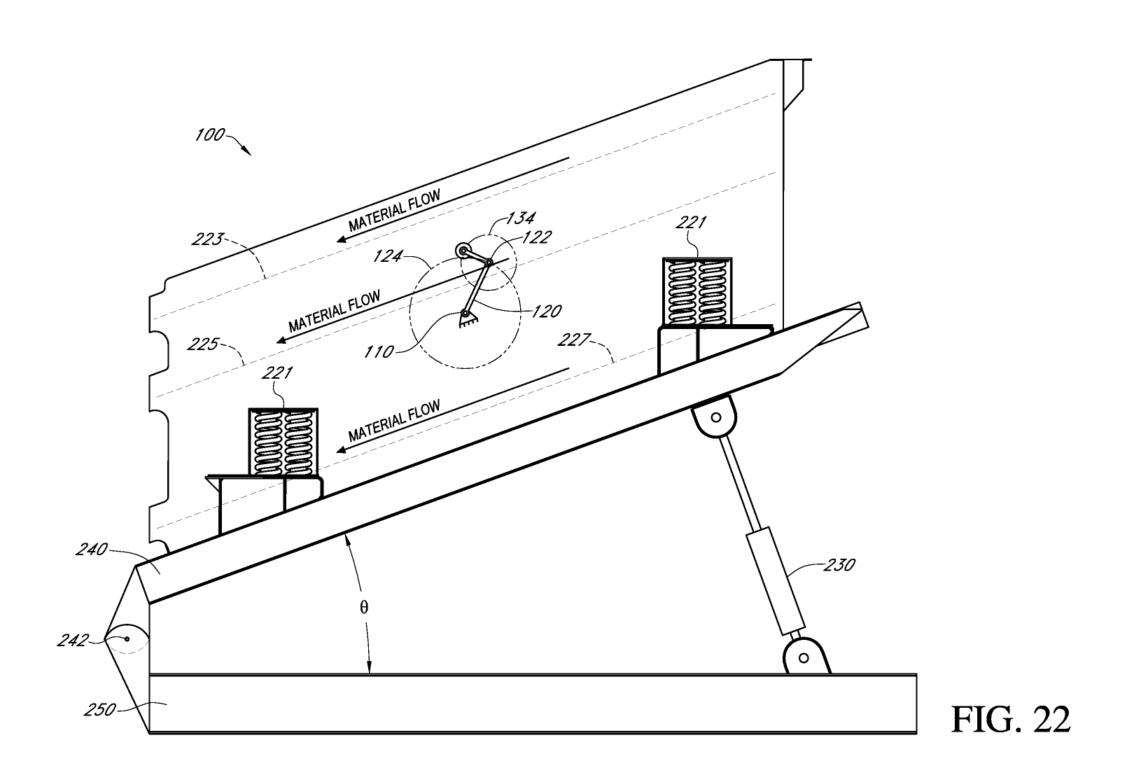

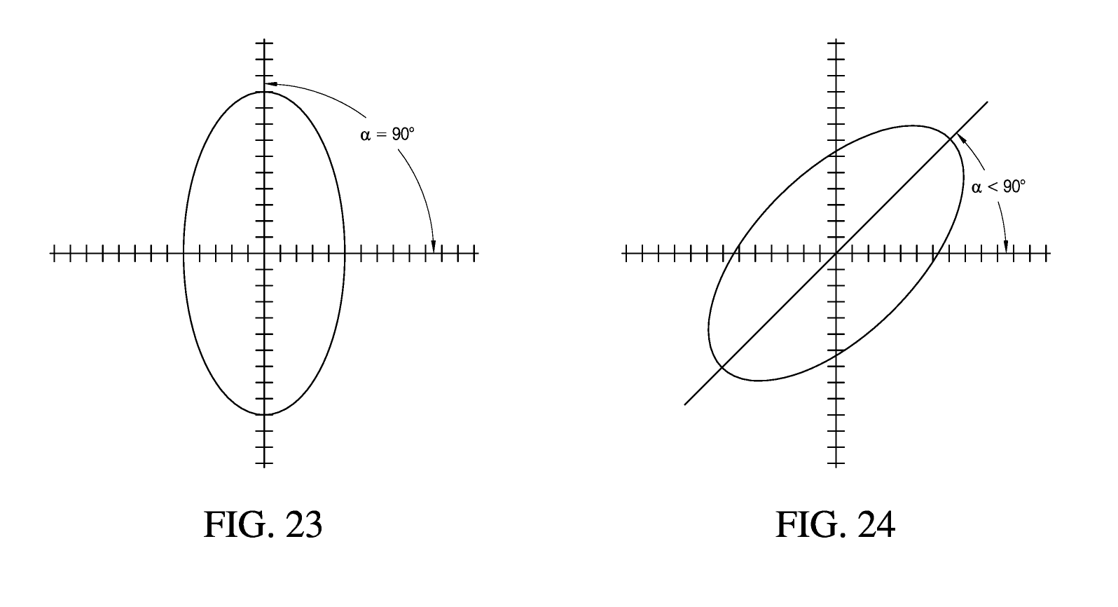

The outside gear 92 could be plucked from the inside gear 90 so that the inside gear interior teeth 91 and outside gear exterior teeth 93 do not mesh. The outside gear 92 of FIG. 9, which has the mass 135 disposed on a line extending between the distal long arm end 122 and the single shaft 110, is revolved around the single shaft 110 and placed back into the inside gear 90 so that outside gear exterior teeth 93 and inside gear interior teeth 91 mesh and so that mass 135 is still disposed on a line extending between the distal long arm end 122 and the single shaft 110. This will result in the ellipse that represents the stroke of a portion of the screen deck being inclined so that the angle alpha is now larger than 90 degrees, this would result in a retarding of the propagation rate of the material along the screen deck. (This assumes that the exit end of the screen is to the right of the input end, as is shown in FIG. 22.) An adjustment of alpha that would accelerate the propagation of material may be more easily understood by now referring to FIGS. 23 and 24 where the longitudinal axis of the ellipse has been adjusted away from the 90 degree orientation of FIG. 23 to a forward propagating orientation with an alpha less than 90 degrees could be obtained using the same method as described at the beginning of this paragraph, except that the outside gear 92 would be placed on a downwardly sloping line instead of the upwardly sloping line as discussed above.

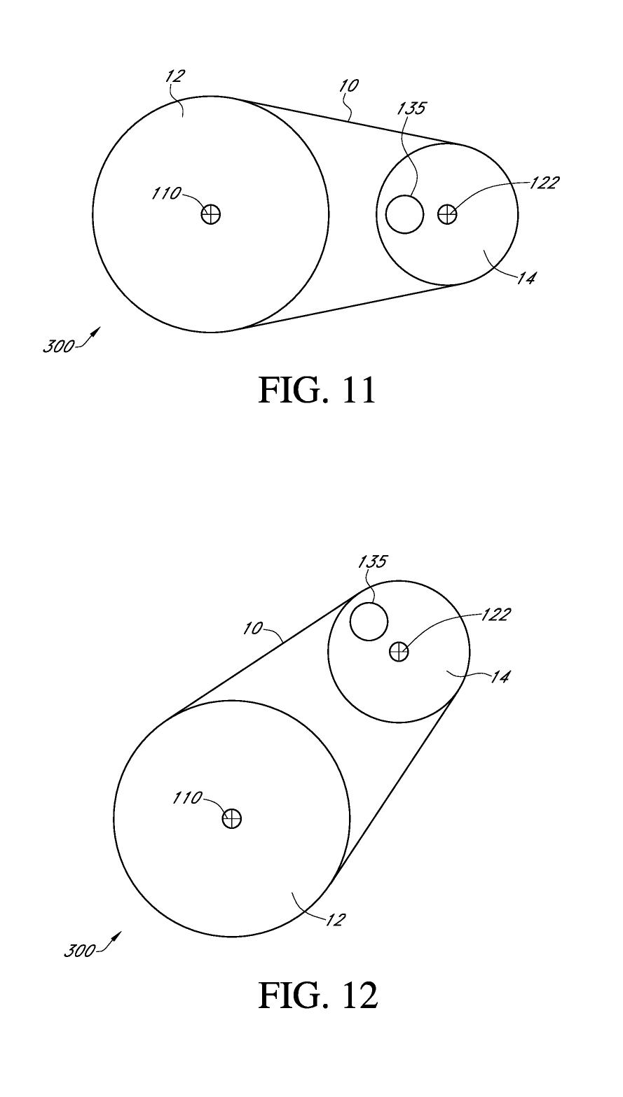

Now referring to FIG. 11, there is shown a chain and sprocket system 300 of the present invention which is designed to approach the operation of FIGS. 1-8 except that the single shaft 110 turns a large sprocket 12 or cog-belt receiving wheel or the like, which, when turned, results in the small sprocket 14 revolving around single shaft 110 in a counter-clockwise direction and also causes the small sprocket 14 to rotate in a clockwise direction at twice the angular speed around distal long arm end 122 (here there is no physical long arm present—the term now referring to the distance from the single shaft 110 to the distal long arm end 122).

Now referring to FIG. 12, there is shown an orientation of the chain and sprocket system 300 which corresponds to the orientation shown in FIG. 2.

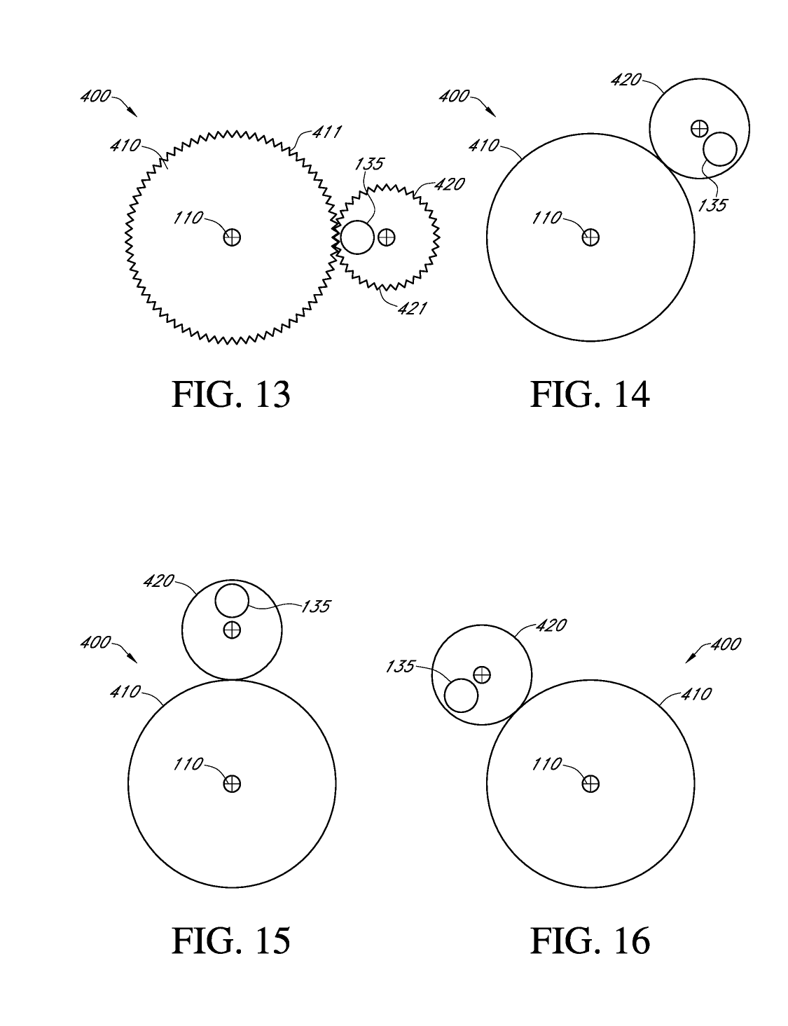

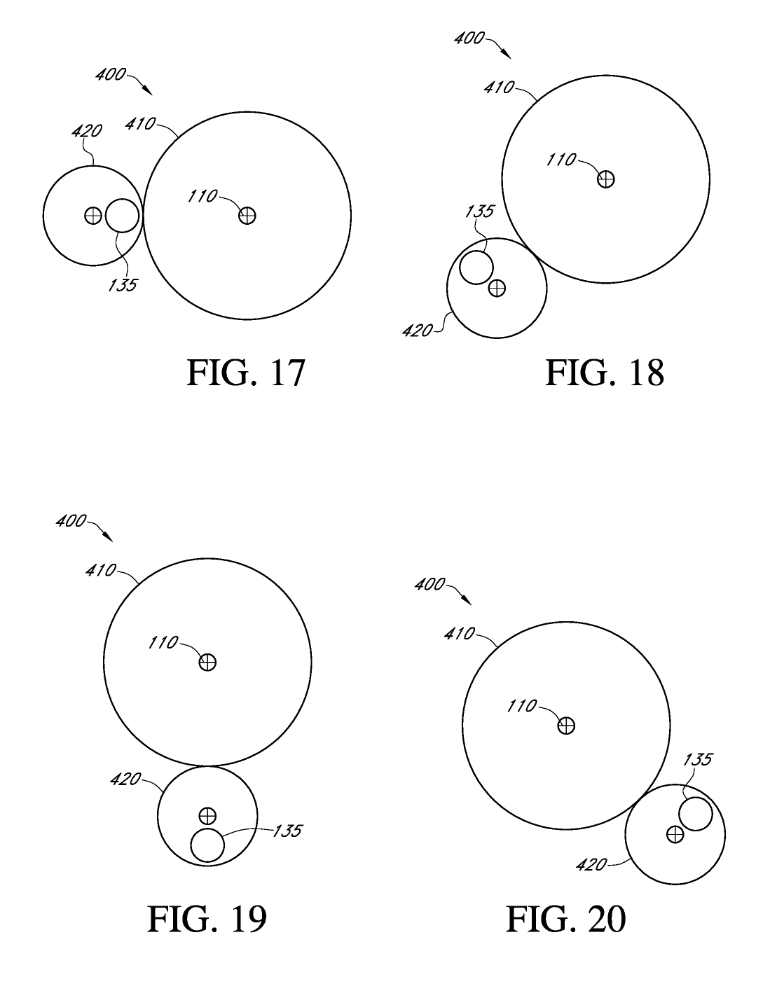

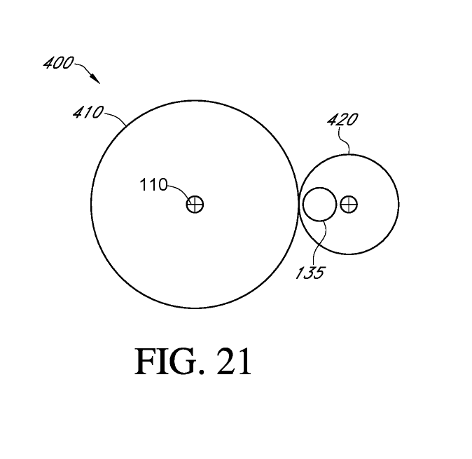

Now referring to FIG. 13, there is shown a non-circular, non-elliptical stroke generating mechanism 400 of the present invention, which in some applications may possibly have some particular advantages depending upon the particular needs of the application. Non-circular, non-elliptical stroke generating mechanism 400 includes a large externally toothed gear 410 coupled to a single shaft 110, the teeth 411 on large externally toothed gear 410 will mesh with the teeth 421 of small externally toothed gear 420. As the single shaft 110 rotates one eighth of a turn, the non-circular, non-elliptical stroke generating mechanism 400 will appear as shown in FIG. 14, which is not the same orientation as shown in FIG. 2. However, the non-circular, non-elliptical stroke generating mechanism 400 shown in FIG. 15 is oriented with the mass 135 in a configuration corresponding to FIG. 3. This variation may prove to be desirable in some applications. Small sprockets 14-21 each show the non-circular, non-elliptical stroke generating mechanism 400 after having the single shaft 110 make a one eighth revolution.

Now referring to FIG. 22, there is shown a mobile single shaft vibrating screen with adjustable screen stroke 100, which is shown in a configuration corresponding to FIG. 2. The mobile single shaft vibrating screen with adjustable screen stroke 100 is shown having screen decks 223, 225 and 227 as well as mounting springs 221. The mobile single shaft vibrating screen with adjustable screen stroke 100 is shown on an upper base 240, which is hinged via hinge 242 to a lower base 250. A hydraulic cylinder is shown at the opposing end to provide the force to move the upper base 240 as desired. Of course, the mobile single shaft vibrating screen with adjustable screen stroke 100 could be mounted where the input is on the right and the output on the left and many other variations, which are well understood, could also be utilized.

The precise implementation of the present invention will vary depending upon the particular application. For example, the mass 135 is shown as a single weight disposed on the free end of short arm 130. In some applications, it may be desirable to adjust the operation and this can be accomplished by providing additional weights applied to the distal end of short arm 130 or weights which are simply plug ins on the short arm 130 itself. If an outside gear 92 is used, the weight may be disposed at variable locations thereon. Similarly, the mass 135 could be disposed at variable locations on small sprocket 14 and small externally toothed gear 420. It may also be desirable to adjust the present invention by providing weight at any position along the long arm 120.

It is thought that the method and apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred exemplary embodiment thereof.

I claim:

1. A method of screening material on a horizontal screen deck comprising the steps of:
providing a material processing screening plant with a first side, an opposing second side, an input end, a discharge end and a substantially horizontal screen deck disposed in a gap between said first side, said second side, said input end and said output end;
providing a rotatable shaft having a central axis that extends from said first side to said second side;
providing a first side weight moving mechanism coupled to a first end of said rotatable shaft;
providing a second side weight moving mechanism coupled to a second end of said rotatable shaft;
rotating said rotatable shaft and thereby causing a vibration of said substantially horizontal screen deck to propagate material disposed thereon so as to create a cumulative flow direction from said input end toward said discharge end; and
wherein said material processing screening plant is free of any additional rotatable shafts which extend from said first side to said second side.

2. The method of claim 1 wherein said first weight moving mechanism comprises a weight which is caused to rotate around a first axis which is not said central axis.

3. The method of claim 1 wherein said first weight moving mechanism comprises a weight which is caused to rotate around a first axis which is parallel with said central axis but displaced from said central axis.

4. The method of claim 3 wherein said weight is caused to rotate by rotation of said rotatable shaft.

5. The method of claim 4 wherein said first weight moving mechanism comprises a first long arm rotatably coupled so as to rotate about said central axis.

6. The method of claim 5 wherein said first long arm is coupled to a first short arm which rotates around said first axis.

7. The method of claim 6 further comprising the step of: adjusting a performance characteristic of said material processing screen plant by adding additional weight to said first short arm.

8. A single shaft screening plant comprising:
a screen having a first side and a second side;
a rotatable shaft with a shaft axis, which extends from said first side to said second side;
a first side weight moving mechanism; coupled to a first end of said rotatable shaft;
a second side weight moving mechanism, coupled to a second end of said rotatable shaft;
said first side weight moving mechanism and said second side weight moving mechanism being, in combination, configured so that rotating said rotatable shaft causes a vibration which would increase an aggregate velocity vector of material on said screen in a direction toward a discharge end of said screening plant, if said screen were oriented substantially horizontally.

9. The system of claim 8 wherein said first side weight moving mechanism comprises a plurality of connected rotating arms where one of said plurality of connected rotating arms revolves around said shaft axis and simultaneously rotates around a first axis which is parallel to and displaced from said shaft axis.

10. The system of claim 8 wherein said first side weight moving mechanism comprises an internal gear.
